(19) United States
(12) Patent Application Publication
(10) Pub. No.: US 2007/0022437 A1
(43) Pub. Date: Jan. 25, 2007

(54) Methods and apparatus for providing content and services coordinated with television content

(76) Inventor: David Gerken, Marina del Rey, CA (US)

Correspondence Address: STRAUB & POKOTYLO, 620 TINTON AVENUE, BLDG. B, 2ND FLOOR, TINTON FALLS, NJ, 07724, US

(21) Appl. No.: 11/486,982

(22) Filed: Jul. 14, 2006

Related U.S. Application Data
(60) Provisional application No. 60/701,062, filed on Jul. 19, 2005.
(60) Provisional application No. 60/772,362, filed on Feb. 10, 2006.

(51) Int. Cl. H04N 7/173; G06F 3/00; G06F 15/00; G06F 13/00; G06F 17/00; H04N 7/16; H04N 5/445

(52) U.S. Cl. 725/41; 725/40; 715/501.1; 715/500.1; 725/100; 725/134; 725/142; 725/112; 725/110

(57) ABSTRACT

Methods and apparatus for providing content and services to an Internet-enabled device in synchronization with media content presented on a television, radio or other separate device are described. In various embodiments, information suitable for identifying the media content being presented on a television or radio is detected by an audio or video receiver such as a microphone, video camera or optical receiver built into or connected to a PC or laptop. Corresponding content is then fetched from Internet servers or local memory or storage and displayed on the PC or laptop. Also, a program module-based framework that provides for the delivery of such media-coordinated content across multiple programs and advertisements and multiple content providers is described.

### RELATED APPLICATIONS

The present application claims the benefit of the filing date of U.S. Provisional Patent Application Ser. No. 60/701,062, filed on Jul. 19, 2005 titled “METHODS AND APPARATUS FOR PROVIDING CONTENT AND SERVICES COORDINATED WITH TELEVISION CONTENT” and U.S. Provisional Patent Application Ser. No. 60/772,362, filed on Feb. 10, 2006 titled “METHODS AND APPARATUS FOR PROVIDING CONTENT AND SERVICES COORDINATED WITH TELEVISION CONTENT”, each of which is hereby expressly incorporated by reference.

### FIELD OF THE INVENTION

The present invention relates to methods and apparatus for providing content and/or services coordinated with television content, e.g., for providing content to an Internet-enabled device that is synchronized with content displayed on a television.

### BACKGROUND

As alternative media like the Internet and videogames capture greater consumer mindshare at the expense of television and other traditional media, and as digital video recorders (DVRs) empower television viewers to skip ads, many believe television's traditional ad-supported business model is at risk of eroding.

Meanwhile, consumers, businesses and the media are becoming more experienced with the Internet and interactive media. Over 80% of the U.S. population accesses the Internet at home or work; virtually all large corporations maintain a significant web presence promoting their products, services and brands; and most TV networks, studios and newspapers now consider the web a key element of their long-term business strategies.

In this environment, interactive television (iTV) is emerging as a means for television studios, programmers, cable and satellite operators and advertisers to further engage TV viewers and, in certain iTV models, to better link their television and Internet presence.

Interactive television has existed in some form since the 1950s when the first call-in television interview shows appeared. More recently, iTV has evolved to encompass a variety of more sophisticated approaches including both single-screen set-top box-based models and synchronous dual-screen (TV/PC) models.

Both of these types of iTV models, however, have limitations. Single-screen set-top box models—in which content generally overlays, frames or interrupts the normal television video—while potentially appealing to the viewer controlling the interactions, can be distracting to other viewers. Also, the primary control device, the TV remote control, can be awkward and limiting as a means of interacting. Finally, the lack of sufficient standards across the wide range of set-top box manufacturers and models can present significant development challenges for television programmers and advertisers wishing to offer the same interactive experience to a broad, cross-system audience.

Current dual-screen (TV/PC) enhanced TV models also have limitations. With typically no communication link existing between the PC and television to enable content synchronization, dual-screen experiences are generally available to viewers only at programs' original broadcast times; i.e., they are generally not available for time-shifted viewing or viewing from pre-recorded media such as DVDs and video tapes.

Also due to the lack of communication between the PC and TV, viewers must play an active role in initiating dual-screen enhanced-TV experiences. Viewers must typically 1) seek out URLs specified by television programmers, 2) indicate the time zones from which they are viewing, and, in some cases, 3) register with the individual programs or networks to participate in the enhanced experiences.

In addition, because such enhanced-TV-experiences may be offered by a variety of programs, networks, or other content distributors, the user experiences can be highly fragmented, with each content provider requiring their own application and/or registration process for viewers to enjoy their enhanced television experiences.

In view of the above discussion, it is apparent that there is a need for methods and apparatus which can automate the synchronization of content between the television and PC or other Internet-enabled device, irrespective of when a television program is viewed or how it is delivered to the television display. There is further need for methods and apparatus which enable the delivery of TV-synchronous content and related services across a variety of unrelated television programs and content providers in a consistent and coordinated fashion.

### SUMMARY OF THE INVENTION

The present invention is directed to methods and apparatus for providing an enhanced media service. The enhanced media service of the present invention allows for synchronized display of content—including, e.g., entertainment, information, and/or advertising content, on an Internet-enabled device with the display of video, images or information being synchronized with a media presentation being perceived, e.g., viewed and/or listened to. For example, information retrieval and presentation may be synchronized with on a television show being viewed and/or a radio program or other media presentation being listened to. As will be discussed below, a computer system implemented in accordance with the present invention detects embedded program ID and/or time stamp information, or other information which can be used to identify a media presentation, into a media presentation so the information can be detected electronically by monitoring the presentation, e.g., the audio and/or video of the presentation. For example, as a program is displayed on a television or other display device, information embedded into the program or broadcast is detected and then various operations relating to the presentation of additional information which may include advertisements, entertainment or educational material, etc., which is presented to the user in a synchronized manner with the program. Retrieval of the additional information to be presented may occur via a connection to a server over the Internet from which the information can be retrieved.

Since the program ID and/or time stamps are embedded in the television image, visual portion of a presentation and/or audio portion of a presentation in various embodiments, there is no need for RF or infrared transmitters and/or receivers. The broadcast identification information, program ID and/or time stamps can be incorporated in conventional television programs and/or other types of presentations which can be displayed on normal television sets, other display devices and/or listened to using an audio playback device.

In various embodiments of the invention, an enhanced television service is implemented such as to create a new type of enhanced television platform that automatically delivers complementary web content to computers in sync with TV programs and ads. This platform leverages patented technology that provides computers with real-time awareness of the TV content being watched—even when time-shifted—enabling television programmers and advertisers to deliver synchronized dual-screen (TV/PC) experiences to their television audiences.

The enabling technology allows encoding of video signals with a low-bandwidth data stream invisible to the eye but detectable with a special optical detector attached to a television viewer's computer. This data stream is used to repeatedly broadcast unique program IDs and time stamps, thus indicating what a viewer is watching on television and where within the television program she is.

With this information, the enhanced television service system triggers appropriate sequences of “events,” or web content, provided by television programmers and advertisers to complement their television content. The synchronous web content can be created in advance, as would typically be the case for taped television programs, or produced live, as would typically be the case for live-to-air programs, and is automatically transmitted to the viewer's computer via the Internet.

Various terms used in this provisional application will now be discussed.

A Content Provider is, for example, an entity that provides any kind of content displayed on a television including programs, advertisements or videos. Content providers can include, e.g., studios, networks or advertisers, among others.

A television program is, for example, content created or adapted for display on a television—including traditional television shows (e.g. sitcoms, dramas, reality TV shows, news programs, game shows, cartoons, televised sporting events, etc.), television advertisements, and movies, among other content forms—irrespective of how the content is delivered to the television (e.g. via broadcast television, cable, recording/playback device, pre-recorded media, etc.).

An Event can be, e.g., an action. An event may involve, e.g., fetching of an enhanced television service content page. An event can include more than one action, e.g., a set of actions to be executed on a television viewer's computer or other Internet-enabled device at a specified point in time in an encoded television program.

An Event Trigger can be, e.g., a specified point in time in the television program, or other trigger. A time based event trigger can be designated by a program time stamp, at which the event is to be executed.

An Event Sequence Module (ESM) is a sequence of events, event trigger information and/or other event related information associated with a television program.

Enhanced Television Service Content Page the content, typically a web page, displayed as part of the enhanced television service experience. Enhanced television service content pages will generally be created specifically for the enhanced television service dual-screen experience, although existing, traditional web pages may be used as well.

Design principles underlying the enhanced television service system of the present invention include:
a style that is simple, clean, easy-to-use, intuitive, non-technical, minimalist, non-intrusive, ergonomic and efficient
an experience that appeals to both passive and active television viewers
an experience that enhances viewer involvement with television programs rather than providing frequent off-ramps to the Internet
sensitivity to viewers' privacy concerns

Functional Overview

The enhanced television service system performs, in some embodiments, one or more of three primary functions and numerous supporting functions. The primary functions include:
1) Receiving and decoding embedded visual or audio information—A visual or audio information detector detects the video or audio output of a media presentation device such as a television. The output signal of the visual or audio information detector is then translated into actionable data based on interface specifications provided by the licensed-technology vendor. The enhanced television service system includes a visual and/or audio program information/processing module, as shown in FIG. 1, for performing this function.
2) Initiating and managing event sequences—The event sequences, created to complement specific television programs, including advertisements, may be pre-programmed, as would typically be the case with taped television programs, or produced live, as would typically be the case with live-to-air television programs. These sequences may include both non-interactive and interactive (such as trivia questions or viewer polls) elements and may come in multiple versions targeting different demographic groups, television markets or other viewer segments. These sequences are specified using event sequence modules (ESMs) initiated by the visual program information monitoring/processing module shown in FIG. 1.
3) Tracking and reporting—Accurate reporting on what content is delivered to whom and what revenue is attributable to which viewers/detectors is critical for purposes of billing, performance measurement and management of revenue-sharing distribution agreements. These operations are enabled by user traffic logs, shown in FIG. 2, which record system activities associated with each user and/or device/detector.

In addition to these primary functions, the enhanced television service system provides various viewer tools (e.g. a user/device profile management function, a bookmarking function, a freezing/unfreezing function, an enhanced television service program guide) and content-provider tools (e.g. enhanced television service content development and management tools).

Select Functional Requirements

In various, but not necessarily all embodiments, one or more of the following select functional requirements are supported and can be used as a basis for more comprehensive system implementations in the future.

User Interface This feature is supported by user interface module 128 shown in FIG. 1. The basis for a user interface is the data entity referred to as an enhanced television service “frame,” which is used to provide users a common viewing window and tool set across the numerous enhanced television service experiences offered by television programmers and advertisers. The enhanced television service frame is akin to a web browser in traditional web surfing, though more basic in function and supporting a more controlled, scripted experience. It includes:
A top-centered “Now watching: [program name]” label indicating the name of the program currently being viewed, as specified by the content provider. This label can be continuously updated based on the program ID detected in the video signal.
Window sizing controls similar to those provided in traditional web browsers.
A “user: [user name]” label indicating the user name of the current enhanced television service user as registered with the service.
A collection of five offline control icons. “Offline controls” refers to those typically accessed by users when not immediately engaged in an enhanced television service experience. These include:
   “users”: clicking on this icon opens a separate window where users can update their profiles or passwords, change users by selecting from a list of users registered on the computer, or register as new users. Users have the option to password-protect their personal enhanced television service environments.
   “settings”: opens a separate window where users can set personal preferences including the length of time to retain bookmarks, the sound heard at page transitions, and whether or not to confirm user-requested sharing of information with content providers
   “guide”: opens a separate window showing a schedule of current and upcoming enhanced television service-enabled programs
   “bookmarks”: opens a separate window where users can view pages bookmarked during their enhanced television service experiences
   “help”: opens a separate window where users can access FAQs, view an illustrative screen shot of the enhanced television service frame with descriptions of each button and label, and contact customer support
A “freeze” button: Clicking on this button disengages the user from the enhanced television service experience, freezing on the currently displayed enhanced television service content page. Once clicked, the button changes to a flashing “unfreeze” button. While in freeze mode, the service continues to load/preload enhanced television service content pages (undetectable in the background) as it would in regular operation to enable rapid re-engagement with the enhanced television service experience when requested. When the “unfreeze” button is clicked, the user is re-engaged with the enhanced television service experience and the most recent enhanced television service event is immediately executed.
A “bookmark” button: Clicking on this button saves a link to the currently displayed enhanced television service content page in a list of bookmarked pages. Bookmarked pages are designated by the program name (that specified by the content provider for the “Now watching” label) and the actual time the page was bookmarked (e.g. “NBC Evening New—6:21 PM”). Bookmarks are dropped from the list according to the user's preference setting.

Also supported is automatic updating of the enhanced television service software as and when determined by the enhanced television service.

Supported Content Models

The enhanced television service system of the present invention supports a number of different television and enhanced television service content models. Specifically, the enhanced television service supports:
Both live-to-air and taped television programming. Content providers are able to either provide pre-programmed enhanced television service event sequences in advance of program airing, as would typically be the case with taped TV programs, or produce those sequences live, as would typically be the case with live sporting events or other live-to-air programming.
Both scheduled and time-shifted viewing. This requires that, for some programs, multiple versions of each Event Sequence Module (ESM) are available to accommodate the different enhanced television service experiences that can be offered to scheduled versus time-shifted viewers, such as real-time viewer polls, viewer competitions, etc.
Customization of the enhanced television service experience for different viewer groups. That is, the enhanced television service enables television programmers and advertiser to deliver different enhanced television service experiences to different viewers based on their demographics (e.g. male 18-24 vs. female 35-49), location (e.g. Los Angeles vs. New York television markets) or various other targeting parameters.
Both passive and interactive enhanced television service content. In the case of the latter, content providers may wish to present interactive content involving both individual-oriented interactions (e.g. answering a trivia question) and group-oriented interactions (e.g. participating in a real-time viewer poll or game show competition). The enhanced television service supports the delivery of such experiences within the enhanced television service-hosted delivery model.
Content providers' desire to occasionally provide off-ramps to the Internet, such as a link to a web page enabling viewers to purchase a featured product. To maintain a clear distinction between the controlled, enhanced television service-hosted experience and external web pages, clicking on a web link within an enhanced television service content page typically opens the user's default web browser, sized such as to not completely mask the ongoing enhanced television service experience.

Content Delivery Process

The delivery of enhanced television service content to a computer in sync with television programs conforms to the following requirements. The enhanced television service system:
Continuously decodes the signal received by the visual and/or audio information detector as per the technology vendor's specifications.
When an encoded television program is detected, fetches the corresponding ESM from the local cache or ESM server (or, in the case of live programming, begins polling the appropriate enhanced television service staging server) and executes the specified events at the specified event triggers.
Continuously preloads upcoming enhanced television service content pages. Also, to enable the enhanced television service to continue executing an ESMs even when the encoded video signal is briefly blocked or when momentary decoding errors occur, program time stamps can be inferred from previous time stamps and the computer's own internal clock.
In the case of television programs for which the corresponding enhanced television service content is produced live (e.g. live sporting events, news), continuously polls the appropriate enhanced television service content-staging server to detect newly available content pages and corresponding event triggers. Content providers can post content pages many seconds or minutes in advance of their trigger times to enable preloading of pages as far in advance as practical.
To ensure a more continuous and immediate TV-like experience, can display enhanced television service content pages only once they are fully downloaded.
Plays a distinct transition sound at the moment each new enhanced television service content page is displayed. Users can be offered a small selection of transition sound options within their user preference settings.
Preloads and caches ESMs to speed the launch of enhanced television service event sequences when a new encoded television program is detected. Preloading methods include:
   On the first instance of detecting an encoded video signal that suggests a viewer is watching a television program within a specified time threshold of its scheduled broadcast time, fetch ESMs for enhanced television service-encoded programs known to be airing in current and upcoming time periods. Repeat this process periodically thereafter until the user closes her enhanced television service session.
   Cache ESMs of television ads viewed. A configurable amount of memory can be allocated for storing ad ESMs. Once this allocation is full, the ESMs of newly-viewed ads (or previously-viewed ads in cases where the associated ESMs have expired) can replace others based on the time since the ads were last observed (i.e. ESMs associated with ads not observed for the longest period of time can be discarded first).
   Preload ESMs for all television ads known to currently be in heavy rotation, either as specified by advertisers or as observed based on the enhanced television service's national or regional traffic patterns.
If no encoded video signal is detected for more than a specified number of seconds (as when a viewer changes channels to an un-encoded program), begins flashing “<searching>” in the “Now watching:” label and freezes on the currently displayed enhanced television service content page.
If no encoded video signal is detected for more than a specified number of seconds, displays a scrolling list of enhanced television service-encoded programs available for viewing in current and upcoming time periods, including their start times, networks and program names. The forward time horizon can be dependent on the number of encoded programs available such that no more than a specified number of hours of programming are listed.
Automatically detects viewer's recent average connection speed, continuously or periodically, and applies this information in selecting appropriate ESMs when multiple ESM versions are available for different connection speeds.
If for any reason the enhanced television service content servers are unreachable (for example, if the viewer's Internet connection goes down or a server times out) and all preloaded content pages have been exhausted such that the enhanced television service experience cannot continue without regaining access to the servers, displays an error message within the enhanced television service frame indicating either “No internet access. Please check your connection.” or “Servers unreachable. Please wait.”
In cases where a requested ESM has expired, displays within the enhanced television service frame the message “Sorry, the enhanced TV content for [program name] has expired.”
   ESM Library

The enhanced television service system includes a centralized ESM library and content servers containing ESMs and corresponding enhanced television service content pages that can be accessed and modified by the enhanced television service and/or content providers. The ESM library and corresponding enhanced television service content, implemented in accordance with the present invention, may be hosted by the enhanced television service or its service partner or vendor to ensure consistent performance.

In cases where content providers choose to use existing, traditional web pages as enhanced television service content, the enhanced television service provides for replicating these pages on enhanced television service-controlled servers to reliably accommodate the predictable traffic spikes inherent in the enhanced television service model. Such copies can be periodically updated to reflect any changes in the originals.

The ESM library of the present invention includes an index system for ESMs specifying:
unique program ID
program name (as will appear in the “Now watching:” label)
program description
program running time
original program broadcast dates and times
content creator/owner
authorized administrator
ESM version number
date created
date last modified
expiration date and time
designed for scheduled or time-shifted viewing (the former able to accommodate different real-time interactions such as viewer polls)
targeting parameters (optional, see below)
complete list of event triggers and corresponding event instructions

Optional ESM targeting parameters are also supported including:
standard demographic groups
designated market areas (DMAs)
connection speeds
   Additional targeting parameters (e.g. reported household income) may, and sometimes are, also included.

Each ESM, in one exemplary embodiment, includes descriptors for each event, representing the page titles to be displayed in bookmark lists (e.g. “NBC News: Outlook for the Housing Market”). In the case of recorded television programming, these titles can, and in various embodiments are, manually specified by content providers during ESM development. In the case of live programming, they can be generated automatically (e.g. [program name]: [time broadcast]), unless otherwise provided by content providers, in which case the information provided by the content provider is used.

The ESM library of the present invention provides content providers the ability to search, review and edit ESMs and associated enhanced television service content pages.

In addition, to provide enhanced television service experiences for time-shifted viewing of live-to-air TV shows (e.g. sporting events, news), the enhanced television service provides a mechanism for content providers to automatically generate ESMs and capture the corresponding enhanced television service content pages from live enhanced television service productions. This mechanism is sensitive to the fact that certain experiences (e.g. viewer polls) may not be available to time-shifted viewers.

Data Management & Reporting

From a data management and reporting standpoint, the enhanced television service system can:
Initiate viewer registration on installation of the end user system, at which time one or more viewers may register. Viewers are also able to register via the “add user” feature mentioned previously. Requested profile data can, and in some embodiments does, include:
   required fields: name, screen name, email address, birthday, gender, zip code
   optional fields: mailing address, household income range, opt-in to receive email announcements from the enhanced television service
Following entry and confirmation of the registration data, present users with the enhanced television service's privacy policy and terms & conditions, at which point users can be asked to confirm the terms before continuing.
Enable one- or two-click (request + confirmation) sharing of select viewer profile information with television programmers and advertisers, depending on the viewer's preference setting.
   When a designated button on an enhanced television service content page is clicked indicating a viewer's interest in sharing personal information with a requesting television programmer or advertiser (such as to receive product information from an advertiser or to register to participate in a game show play-along), the viewer's default web browser can be opened to an enhanced television service-managed page including the data fields requested by the content provider, pre-populated with the available viewer profile data. If other data fields are requested by the content provider, the user may add this data as desired. In cases where the additional data provided by the user to the content provider is relevant to the enhanced television service, the enhanced television service can add this data to its own profile record for that viewer. When complete, the user can be asked to click on a confirmation button to complete the data transfer.
Provide the ability to track and report the revenue generated from each individual visual and/or audio information detector based on a unique detector ID. This capability is intended to support the enhanced television service's distribution strategy of working with various distribution partners, each entitled to a specific share of the revenues generated from the detector units they distribute.
Provide the ability for content providers and enhanced television service administrators to generate reports summarizing:
   the number of viewers who downloaded at least one enhanced television service content page associated with each specified television program run within a specified time period
   among those viewers, the distributions by share of associated content pages viewed and the time viewed
   for any given ESM, the number of viewers who authorized the exchange of information with the associated content provider.

Additional features, embodiments and benefits of the methods and apparatus of the present invention will be discussed below in the detailed description which follows.

### BRIEF DESCRIPTION OF THE DRAWINGS

FIG. 1 illustrates an end user system implemented in accordance with the present invention.

FIG. 2 illustrates an ESM and content provisioning system which can be used in combination with the end user system of the present invention shown in FIG. 1.

FIG. 3 illustrates a visual program information monitoring and processing routine which may be used to implement the visual program information monitoring and processing module of FIG. 1.

FIG. 4 is a flow chart showing the steps of executing an exemplary event sequence module, which may be one of the ESMs shown in the systems of FIGS. 1 and 2, implemented in accordance with the invention.

FIG. 5 is a flow chart illustrating the steps of an ESM supplying method performed by an exemplary ESM server, such as the ESM server of FIG. 2, in accordance with the invention.

FIG. 6 is a flow chart illustrating a program ID and ESM generation method that may be performed by the program ID and ESM generation module of FIG. 2.

FIG. 7 illustrates two sample event sequence modules implemented in accordance with the present invention.

FIG. 8 illustrates additional sample event sequence modules implemented in accordance with the present invention.

FIG. 9 illustrates a sample user/device profile implemented in accordance with the present invention.

FIG. 10 illustrates an alternative sub-process in accordance with the present invention.

FIG. 11 is a drawing of a flowchart of an exemplary method of providing at least some additional content in conjunction with an ongoing media presentation in accordance with various embodiments of the present invention.

FIG. 12 is a drawing of a flowchart of an exemplary method of operating a network device in accordance with various embodiments of the present invention.

FIG. 13 is a drawing of an exemplary user apparatus 1300 in accordance with various embodiments of the present invention.

FIG. 14 is a drawing of an exemplary network device 1400, e.g., server, in accordance with various embodiments of the present invention.

### DETAILED DESCRIPTION

The present invention relates to methods and apparatus for providing content and services coordinated with television content, e.g., for providing content to an Internet-enabled device that is coordinated with content displayed on a television.

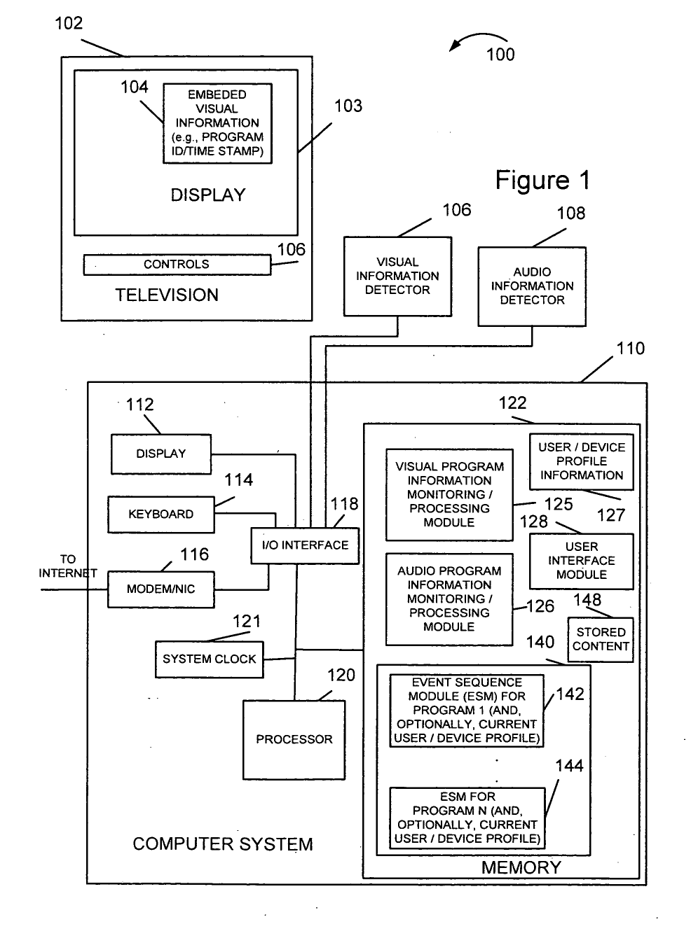

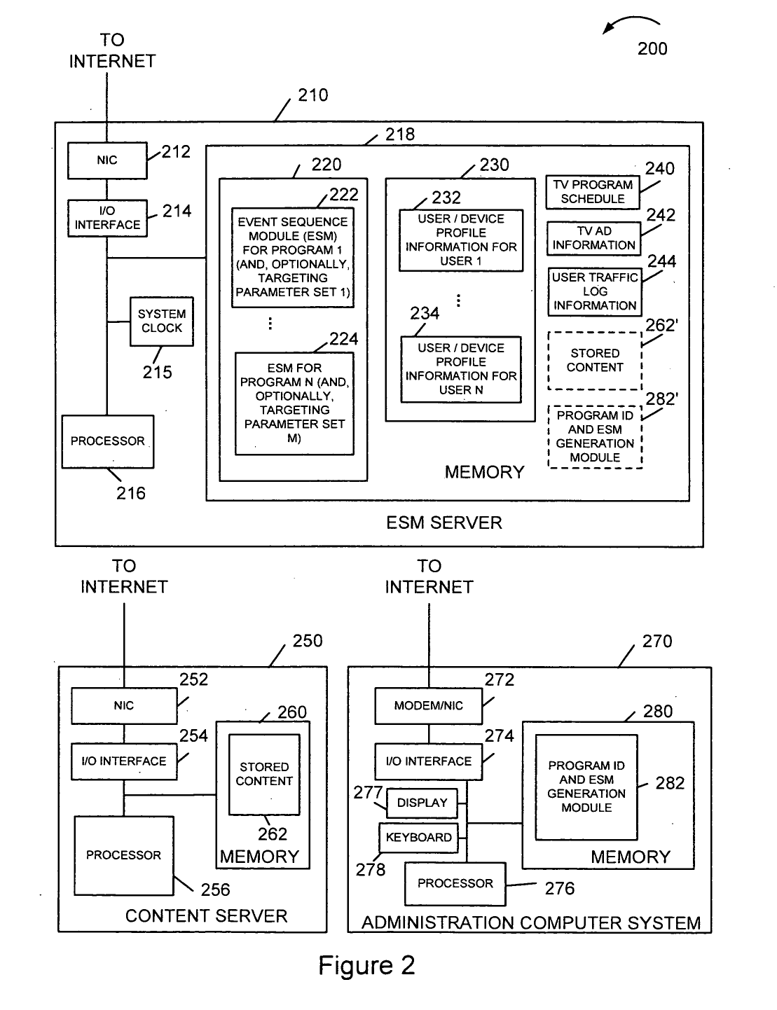

FIG. 1 illustrates a system 100 implemented in accordance with the present invention. The system 100 may be located at a customer premise, e.g., at a home which has Internet access. The system 100 may be located remotely from an ESM server of the present invention, such as the exemplary server 210 shown in FIG. 2.

As illustrated the system 100 includes a TV 102 and a computer system 110. The television includes a display 103 and controls 106. In accordance with the present invention, part of an image or series of images, e.g., a frame or sequence of frames, can include embedded visual information 104. This information may be displayed on a portion of the television device. The embedded information may communicate, in encoded form, information such as program ID and program time stamp information through the use of a visual signal which can be detected by a detection device such as the device 106. Methods of embedding the information in the visual signal generated on the television display may include, but are not limited to, methods such as those described in U.S. Pat. No. 4,807,031 which is hereby expressly incorporated by reference.

While the display device 103 displays embedded visual information 104, the television may be a conventional television 102 used to display a program into which a visual program ID and program time stamps have been embedded. As will be discussed below, the program ID may be assigned by a computer system 270 in accordance with the present invention which also generates Event Sequence Modules (ESMs) corresponding to the program and/or associates existing ESMs with the assigned program ID.

In addition to the television 102, the user system 100 includes a computer system 110, e.g., a PC, media center or other device, which includes a visual information detector 106 for detecting visual information displayed on the television display 103, e.g., embedded visual information included in a program in accordance with the present invention. In addition, the computer system 110 includes an audio detector 108, display 112, keyboard 114, and modem/NIC (Network Interface Card) 116 which are coupled by an I/O interface 118 to a processor 120, system clock 121 and memory 122.

The processor controls operation of the computer system 110 under control of one or more modules stored in the memory 122. The memory 122 includes a visual program information and monitoring processing module 125, an audio program information monitoring and processing module 126, a user interface module 128, and a plurality 140 of event sequence modules 142, 144 which are implemented in accordance with the invention. As will be discussed below, the modules 125, 126, 128 may be implemented as software routines used to control system operation. In addition, memory includes user/device profile information 127 and stored content 148.

As will be discussed below, the visual program information monitoring and processing module 125, when executed, controls the computer system 110, to monitor for, detect and then perform various processing operations in response to embedded visual information 104, e.g., program IDs and/or time stamps, displayed on the display 103. In this manner, the computer system can detect what television program is being displayed, synchronize computer operations and the display of information with the television program being displayed, and take other actions such as reporting the detected viewing of a television program to the server 210 of the present invention. Audio program information monitoring and processing module 126 can monitor for program IDs and time stamps embedded in audio signals generated by the television 102 and can perform the same or similar functions as the visual program information monitoring and processing module 125 with the main difference being in the way the program ID and time stamps are detected.

User/device profile information 127 may include information about the user of the computer system 110, e.g., personal preferences, geographic location, age, gender, email address, mailing address, past consumer purchasing information, information indicating whether the user has authorized sharing of all or portions of the user profile information with content providers, as well as other information. The user/device profile information 127 may also include information about the visual information detector 106 and/or audio information detector 108, including a unique detector ID, as well as information about computer system 110, e.g., its display, data storage and processing capabilities, and Internet connection type and speed. This information can be used to select an ESM version targeted for a specific user profile, to enable the correlation of system activities to specific users or devices for tracking and reporting purposes, or to ensure that the computer system will be able to process and display information in accordance with an ESM supplied to the computer system 110 by the server 210.

The event sequence modules, ESMs 142, 144 include instructions, information and/or data to be used by the computer system when the television program corresponding to the particular ESM is detected. As will be discussed below, the set of ESMs 140 may represent a library of ESMs corresponding to different television programs. However, one or more of the ESMs may be a generic ESM to be used in the event that an ESM corresponding to a specific program ID which is detected is not already in the ESM store 140 and is unavailable,. e.g., because a connection cannot be established with the server 210 or because there is insufficient bandwidth available to download a specific ESM corresponding to a detected program ID in real time.

Stored content 148 may include advertising, entertainment and/or other information which can be retrieved and displayed under control of one or more of the ESMs 142, 144, e.g., in response to detection of a program ID or time stamp.

FIG. 2 illustrates a further system 200 implemented in accordance with the present invention. As illustrated the system 200 includes an ESM server 210, a content server 250, and an administration computer system 270. The ESM server 210 includes memory 218, which includes an ESM library 220, user/device profile information 230, TV program schedule information 240, TV ad information 242, and user traffic log information 244. In one alternative embodiment of the invention, memory 218 also includes stored content 262′ and program ID and ESM generation module 282′. As will be discussed below, stored content 262′ and program ID and ESM generation module 282′ may reside on one or more other computer systems, as illustrated by stored content 262 residing on content server 250 and program ID and ESM generation module 282 residing on administration computer system 270.

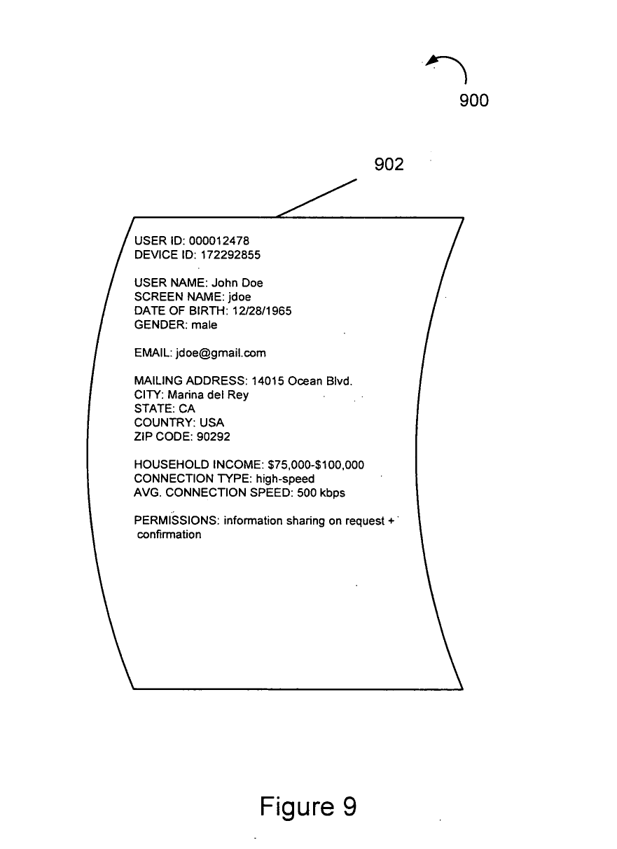

ESM library 220 includes a plurality of ESMs 222, 224 which are implemented in accordance with the invention. User/device profile information 230 includes information sets 232, 234 for a plurality of users. FIG. 9 shows an illustrative example of an information set comprising a user/device profile. In addition, the ESM server 210 includes a NIC (Network Interface Card) which is coupled by an I/O interface to processor 216 and memory 218.

As will be discussed below, ESM server 210 responds to requests from a user computer system 110 for ESMs corresponding to programs displayed on a television or other display device. Also discussed below, ESM server 210 optionally provides a user computer system 110 with ESMs and/or corresponding content in anticipation of possible future requests from the user computer system based on television program schedule information 240, television ad information 242 and/or user traffic log information 244.

Content server 250 includes memory 260 which contains stored content 262. In addition, content server 250 includes a NIC 252, I/O interface 254 and processor 256. As discussed below, content server 250 provides a user computer system 110 with content specified by ESMs.

Administration computer system 270 includes memory 280 which contains a program ID and ESM generation module 282, the implementation of which will be discussed below. In addition, system 270 includes a modem/NIC 272, I/O interface 274, processor 276, display 277 and keyboard 278.

It is understood that while system 200 is shown in FIG. 2 comprised of three sub-systems 210, 250 and 270, the elements of system 200 may reside on one or multiple computer systems in one or more locations. One such alternative implementation is illustrated by stored content 262′ and program ID and ESM generation module 282′, on ESM server 210. In this implementation, stored content 262′ and program ID and ESM generation module 282′ perform the same or similar functions as stored content 262 on content server 250 and program ID and ESM generation module 282 on administration computer system 270, respectively.

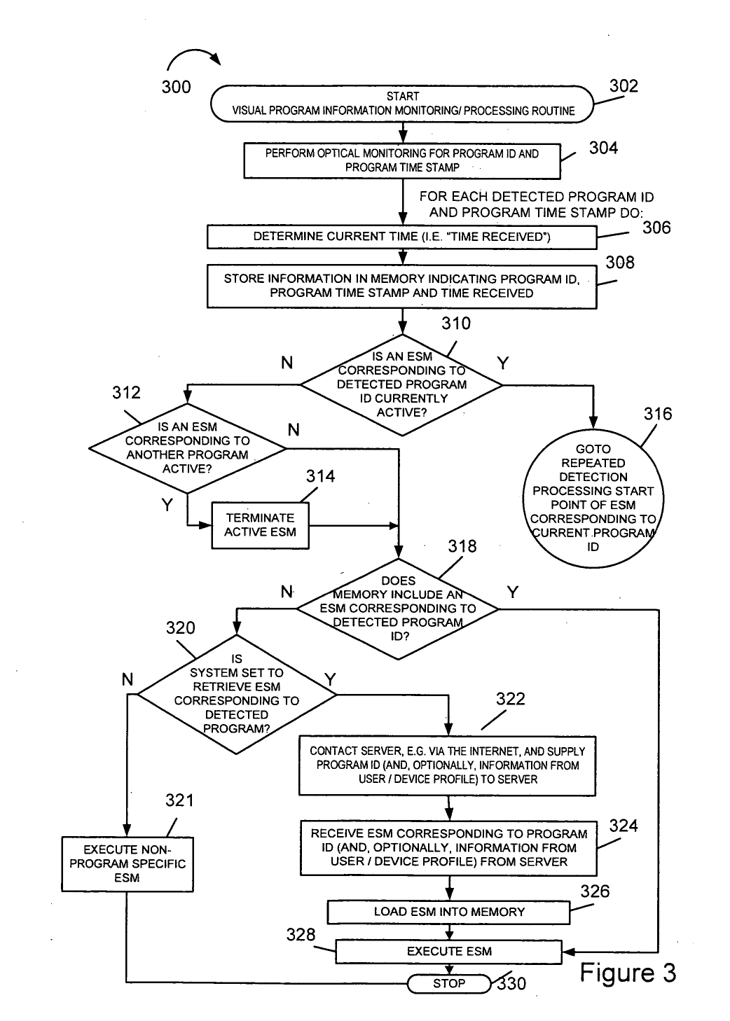

Referring now to FIG. 3, the steps of an exemplary visual program information monitoring and processing routine 300 will be described. The routine 300 may be used to implement the corresponding module 125 shown in FIG. 1.

The visual program information monitoring and processing module 125 begins in step 302 when it is first loaded in the processor 120 and executed, e.g., as part of the start-up process of computer system 110. Operation proceeds from step 302 to optical monitoring step 304 which is performed on an ongoing basis. In step 304, the computer system 110 monitors the output of the system's visual information detector 106 for a program ID and/or program time stamp which may be included in a television program being displayed on a nearby display device, e.g., exemplary television display 103. Each time a program ID or time stamp is detected, operation proceeds to step 306. Since monitoring is performed on an ongoing basis, the subsequent program IDs and/or time stamps will be detected and processed even if the processing of a previously detected time stamp or program ID has not stopped.

In step 306, the computer system determines the current time as indicated, e.g., by an internal system clock 121. The current time is used as a received time. This actual time can be correlated, e.g., to detected program time stamps which may be referenced to the start of the program for which a program ID was detected.

Once the received time is determined, the received time is stored in memory along with the detected program ID and a program time stamp if one was detected. This information can be used later, e.g., for retrieving and/or displaying information in a synchronized manner with the displayed television program.

Operation proceeds from step 308 to step 310. In step 310 a determination is made as to whether or not an ESM corresponding to the most recently detected program ID is currently active, i.e., being executed as the result of an earlier detection of a program ID corresponding to the same program. If an ESM corresponding to the detected program ID is currently active, operation proceeds via GOTO step .316 to a repeated detection processing start point of the active ESM corresponding to the current, e.g., most recently detected, program ID.

However, if in step 310, it is determined that an ESM corresponding to the most recently detected program ID is not active, operation proceeds to step 312. In step 312 a determination is made as to whether or not an ESM corresponding to another program is active. If an ESM corresponding to another program is active, the active ESM corresponding to the other program is terminated in step 314 before operation proceeds to step 318. However, if in step 312 it is determined that an ESM corresponding to another program is not active, operation proceeds directly to step 318.

In step 318, the memory is checked to determine if it includes an ESM corresponding to the most recently detected program. This can be done by checking ESM store 140 to see if it includes an ESM corresponding to the most recently detected program ID. If the memory 122 includes an ESM corresponding to the detected program ID, operation proceeds directly to step 328 in which the corresponding ESM is executed. Otherwise operation proceeds to step 320.

In step 320 a determination is made as to whether or not the system 110 is set to retrieve ESMs corresponding to detected programs. This setting may be indicated in user/device profile information 127. Assuming Internet connectivity and sufficient communications bandwidth exists, the system 110 will normally be set to retrieve ESMS. However, if there is trouble with the Internet connection or no Internet or other communications connection exists, the system will be set so that it does not try to retrieve a program-specific ESM. If in step 320, it is determined that the system 110 is set so that it will not try and retrieve an ESM, operation proceeds to step 321 where a non-program specific ESM is retrieved from the ESM store 140 and executed. However, if in step 320 the system is set to retrieve an ESM, operation will proceed to step 322. In step 322 the computer system 110 contacts an ESM server 210, e.g., via the Internet or another network connection. As part of contacting server 210, the computer system 110 supplies the most recently detected program ID. In addition, optionally, if the user has authorized sharing of user profile and/or device information (or if supplying such information is a default), the computer system will supply user profile and/or device information to the server 210. FIG. 9 shows an illustrative example of a user/device profile from which user/device information can be retrieved. Detected program time stamp information may also be supplied to the server 210.

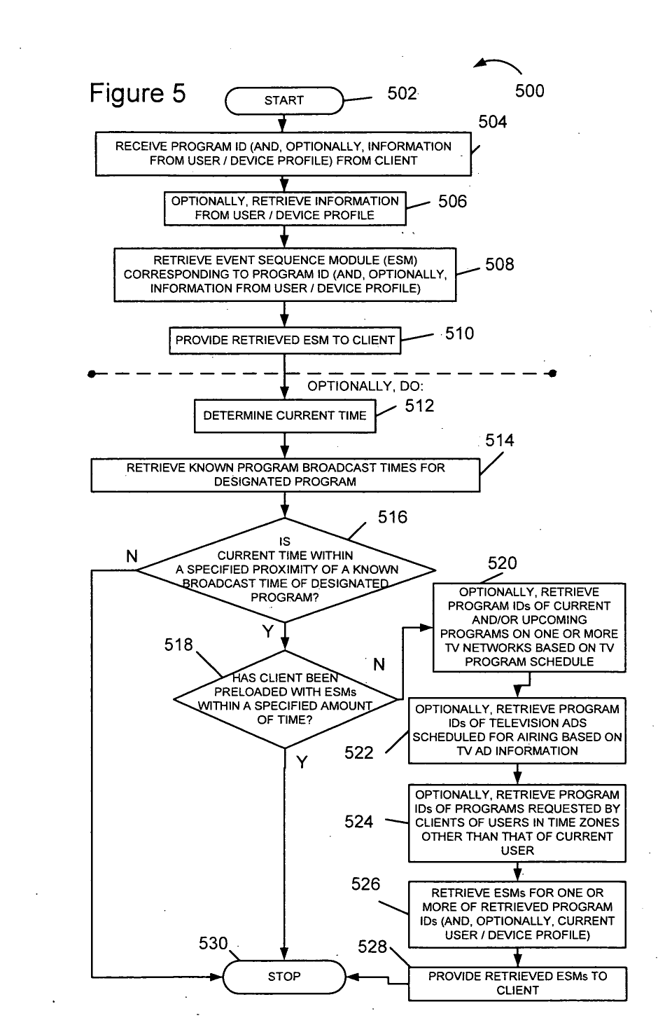

In response to contacting the server 210, the computer system 110 receives from the server an ESM corresponding to the program ID which was detected. The ESM may be further customized or selected by the server as a function of user/device profile and/or time stamp information supplied to, residing on, or otherwise determined by the server. Operation of the server 210 in response to contact from a user's computer system 110 will be discussed further below in regard to FIG. 5.

Following receipt of the ESM in step 324, the ESM is loaded into memory 122 in step 326 and then executed in step 328. With the execution of the ESM in step 328 the ESM is active and processing in response to the detected program ID and/or time stamp. Operation proceeds to step 330 where processing of the detected program ID and/or time stamp, other than processing corresponding to the ESM activated in step 328, stops. As discussed above, although processing of the detected program ID stops in step 330, monitoring for additional program IDs/time stamps will continue.

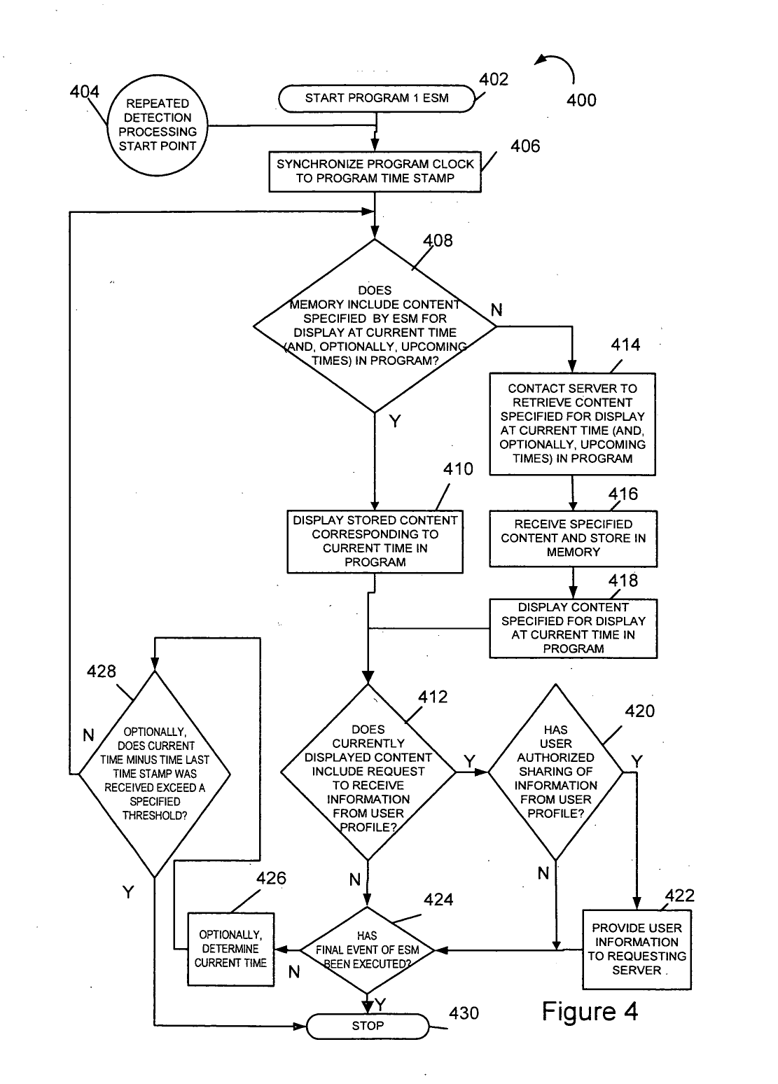

The steps 400 performed in accordance with an exemplary ESM will now be described with reference to FIG. 4. Execution of an exemplary ESM begins in step 402 when an ESM is first loaded in the processor 120 and executed. From the repeated detection processing starting point 404, operation proceeds to step 406 where a program clock is synchronized with the received program time stamp. The synchronization of the program clock with the received program time stamp provides for continued execution of the ESM corresponding to the displayed television program between instances of receiving program time stamps.

Operation proceeds from step 406 to 408. In step 408, a determination is made as to whether content specified by the ESM for display at the current time in the television program resides in stored content 148. If the specified content resides in stored content 148, operation proceeds to step 410 where that content is displayed on display 112. If the specified content does not reside in stored content 148, operation proceeds to step 414 where content server 250 is contacted to retrieve the specified content. Next, in step 416 that content is stored in memory 122 and, in step 418, displayed on display 112.

Optionally, steps 408, 414, 416 may also be executed to preload content into stored content 148 for upcoming ESM events. Such preloaded content can then be displayed later at the program times specified by the ESM.

In step 412, if the currently displayed content includes a request to receive information from the user profile, operation proceeds to step 420 where it is determined if the user has authorized sharing of the requested information. If the sharing of the requested information is authorized, operation proceeds to step 422 where the requested information is provided from user/device profile information 127 on computer system 110 or, alternatively, from corresponding user/device profile in memory module 230 of computer server 210, to the requesting server. Alternatively, the authorization for information sharing may be stored in memory and the user profile information communicated to the requesting content provider at a later time, e.g., such as by CD or by a data file transmitted via email.

In step 424, it is determined whether or not the final event of the ESM has been executed. If so, processing corresponding to the ESM started in step 402 stops in step 430. As discussed above, although processing of the current ESM stops, visual program information monitoring/processing routine 300 continues.

If it is determined in step 424 that the final event of the ESM has not been executed, operation proceeds to step 426. In step 426, the computer system optionally determines the current time as indicated, e.g., by an internal system clock 121. Operation then proceeds to step 428, where, optionally, it is determined whether the current time minus the time the last time stamp was received, as determined in step 306 and stored in memory in step 308, exceeds a specified threshold. Optionally, if the specified threshold is exceeded, operation may proceed to step 430 where execution of the current ESM stops.

If the specified threshold is not exceeded, or if the optional steps 426 and 428 are not executed, operation returns to step 408 where it is again determined whether enhanced television service content for the current time in the television program resides in stored content 148.

The steps 500 performed in accordance with an exemplary routine for fulfilling requests from computer system 110 to ESM server 210 for an ESM corresponding to a detected television program will now be described with reference to FIG. 5. Execution of the ESM fulfillment routine starts in step 502. Operation proceeds to step 504, where the ESM server 210 receives a program ID, and, optionally, information from the user/device profile 127, from computer system 110. Optionally, user/device information for the current user may be retrieved by computer system 210, e.g., from a user/device profile memory module 230, in step 506.

Operation then proceeds to step 508 in which an ESM corresponding to the received program ID and, optionally, to information from the user/device profile is retrieved from ESM library 220. The retrieved ESM is then provided to the requesting computer system 110 in step 510.

A series of further optional steps 512 through 530 can be executed to preload computer system 110 with other ESMs that, based on television network programming schedules, ad information, and/or user log information, may be required in the future by computer system 110 in responding to detected program IDs.

In step 512, the computer system 210 determines the current time as indicated, e.g., by an internal system clock 215. Operation then proceeds to step 514, where known broadcast times for the television program corresponding to the received program ID are retrieved, e.g., from TV program schedule 240.

Proceeding to step 516, computer system 210 determines if the current time is within a specified proximity of a known broadcast time for the television program, thus indicating a potential likelihood that the user of computer system 110 is viewing the specified television program at or near an original broadcast time and, hence, that there is potential value in preloading ESMs and corresponding content for other current and upcoming television programs into computer system 110.

If the current time is determined to be within a specified proximity of a known broadcast time of the specified television program, operation proceeds to step 518. In step 518, computer system 210 further determines if computer system 110 has been preloaded with ESMs within a specified amount of time. If so, operation proceeds to step 530 where routine 500 stops. Otherwise, operation proceeds to step 520, where, optionally, computer system 210 retrieves the program IDs of current and/or upcoming television programs as specified in TV program schedule 240. Likewise, in step 522, computer system 210 optionally retrieves the program IDs of television ads schedule for airing based on TV ad information 242, and, in step 524, the program IDs that have been detected by computer systems of other users of the enhanced television service, e.g., users in later time zones than that of the user of computer system 110, based on user traffic log information 244.

In step 526, computer system 210 then retrieves ESMs corresponding to one or more of the program IDS retrieved in steps 520, 522 and 524, and, optionally, to information from the current user's user/device profile. Operation then proceeds to step 528, where the retrieved ESMs are provided to computer system 110, and then to step 530, where the ESM fulfillment routine stops.

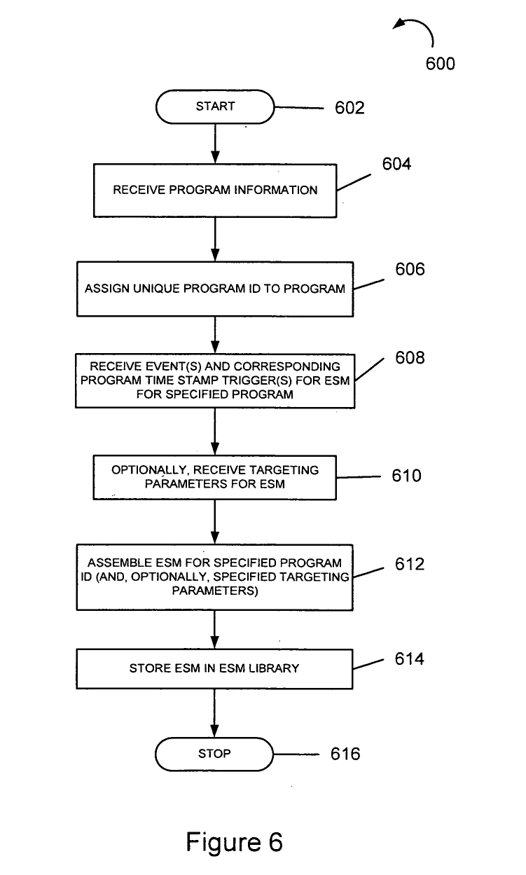

Referring now to FIG. 6, the steps of an exemplary program ID and ESM generation routine will be described. The routine 600 may be used to implement the corresponding ESM library 220 shown in FIG. 2.

The program ID and ESM generation routine 600 starts in step 602 when the program ID and ESM generation module 282 is first loaded in the processor 276 and executed, e.g., as part of the start-up process of computer system 270. Operation proceeds from step 602 to step 604 in which television program information, e.g. program name and scheduled broadcast times, are received by administration computer system 270. In step 606, the program ID and ESM generation routine assigns a unique program ID to the television program. Operation then proceeds to step 608, in which computer system 270 receives one or more events and corresponding event triggers that will comprise an ESM for the specified television program. In optional step 610, computer system 270 may further receive targeting parameters for the ESM—e.g., target geographic locations, age ranges, gender, and/or Internet connection speeds—specifying the segments of the enhanced television service audience for which the ESM applies.

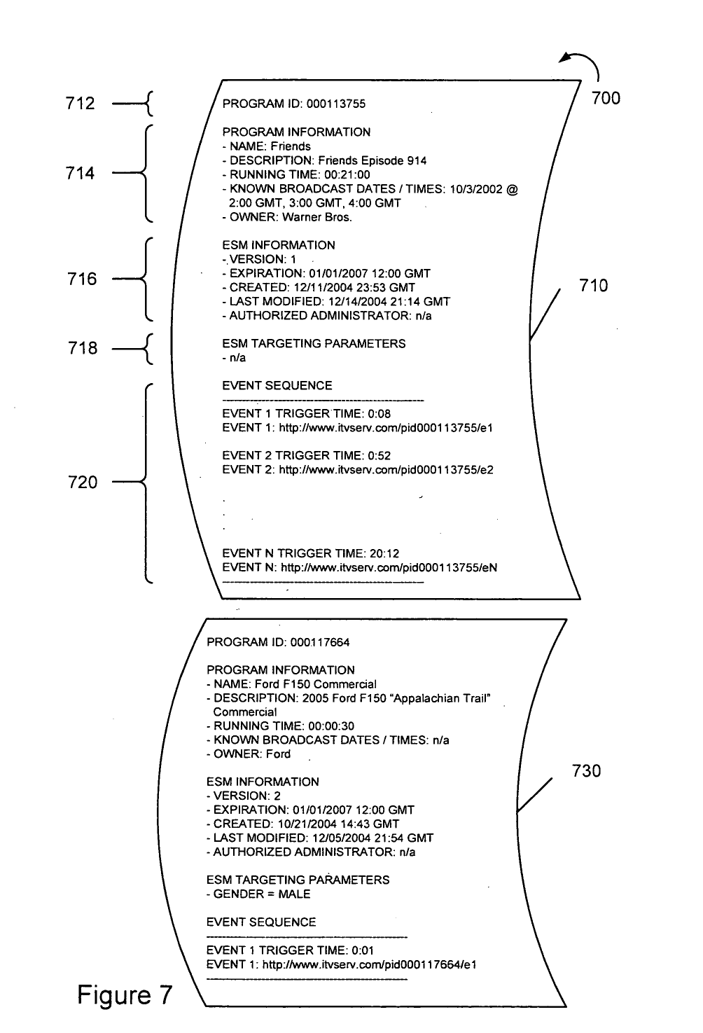

Operation then proceeds to step 612 in which the assigned program ID, program information, events, event triggers and targeting parameters, if any, are assembled to create an ESM for the specified television program. Two illustrative examples of ESMs are shown in FIG. 7, discussed below, including one illustrative ESM 710 for a traditional half-hour television program and one illustrative ESM 730 for a 30-second television advertisement.

Proceeding to step 614, the assembled ESM is provided to ESM server 210 and stored in ESM library 220. Finally, in step 616, the program ID and ESM generation routine stops.

FIG. 7 illustrates two example ESMs 710, 730. As shown in ESM 710, the ESM data structure includes: program ID 712; program information 714, which includes information about the television program with which the ESM is associated, e.g., program name, description, running time, known broadcast dates and times, and/or program owner; ESM information 716, which can include the ESM version number, expiration date, creation date, last-modified date, and/or the authorized administrator of the ESM; optionally, ESM targeting parameters, e.g., geographic locations, age groups, gender, connection speeds, viewing time (e.g. at time of broadcast vs. time-shifted), and/or other specified audience segments for which the ESM is designed; and event sequence 720 which includes one or more event trigger times and corresponding events, e.g., URLs corresponding to the enhanced television content pages to be displayed at the times in the television program specified by the event triggers.

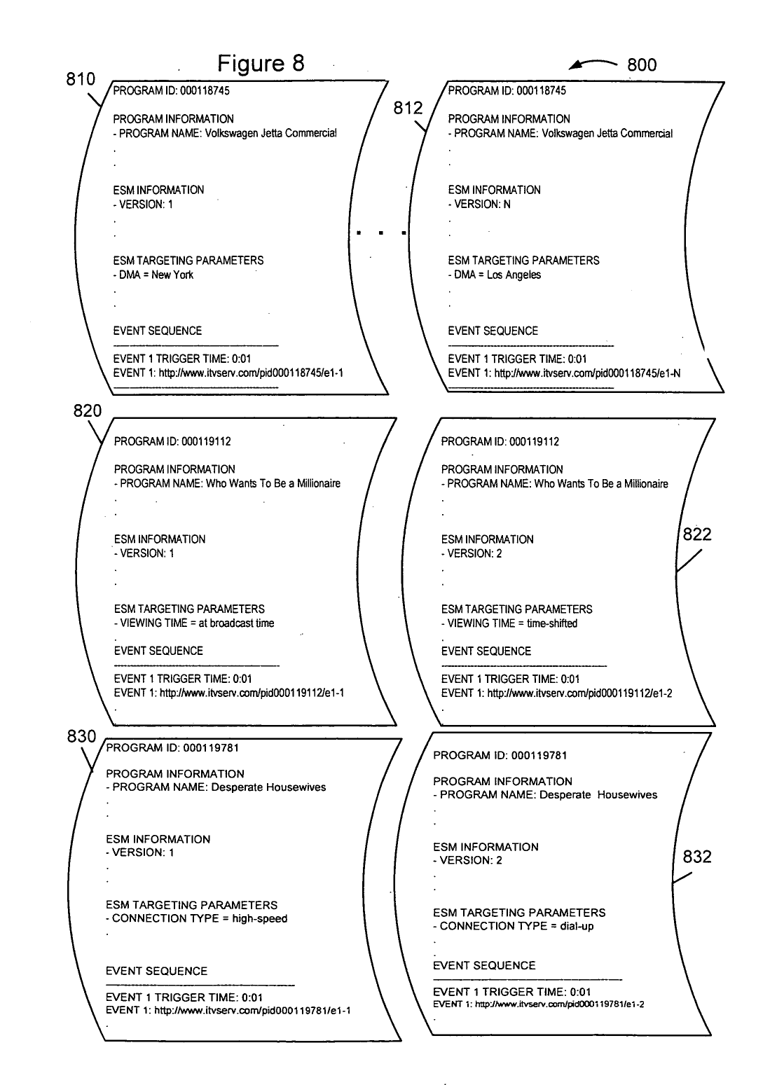

FIG. 8 illustrates ESMs with various optional targeting parameters. ESMs 810, 812 illustrate a plurality of ESM versions corresponding to the same program ID 000118745, each targeting viewers from a specific designated market area, or geographic television market. ESMS 820, 822, respectively, illustrate ESM versions targeting viewers of program 000119112 at known broadcast times versus those time-shifting the television program. ESMs 830, 832, respectively, illustrate ESM versions targeting viewers of program 000119781 with high-speed versus dial-up Internet connections. ESMs with no targeting parameters may thus be designated as suitable for all viewers of the specified television program.

The methods and apparatus of the present invention, which can be used to synchronize information retrieval, e.g., via the Internet, and presentation of retrieved information, e.g., on a computer or other user device such as a portable game device, PDA, media player, etc., with a media presentation such as a television show or radio broadcast, can be implemented using a wide range of signals from the television show, radio broadcast or video presentation to obtain sufficient information to enable identification of the media presentation corresponding to which information is to be retrieved and presented, e.g., in a synchronized manner. As noted above, visual information may be embedded in a television or other visual program which can be detected and used to determine the television program and a time. The time may be, for example a presentation time and/or index used to indicate the relative position within the presentation to the start of the presentation.

In some embodiments, the methods and apparatus of the present invention use other information, rather than a specific program name, to identify the media presentation being perceived, e.g., viewed or listened to. For example, in some embodiments a broadcast identifier, e.g., identifying a broadcaster or program source, and broadcast time information is detected. This information may be detected via an audio, video or other type of detectable signal, e.g., radio signal. The media program being perceived is then determined from broadcast schedule information, e.g., a database of broadcast schedule information for a plurality of broadcasters, e.g., radio, television and/or other types of broadcasters.

In some embodiments, audio signals are monitored using a microphone included in a computer or other device which then retrieves information and presents it in a synchronized manner in accordance with the invention. Such implementations allow notebook computers and/or other devices with audio detection capability and a communications connection to implement the invention without the need for special hardware.

Some additional encoding formats for the media content that triggers ESMs, e.g., broadcaster and/or program identification information, according to this invention will now be discussed.

As described previously, program IDs and program time stamps can be transmitted through optical or audio encoding of the media content, e.g., as embedded data, and conveyed in a manner which may not be perceivable to the viewer or listener without the use of a detection device. As noted above, the embedded data can include a transmission-source—e.g., a television network or station identifier and/or a transmission time stamp which can then be used to determine, e.g., translated to, a program ID and program time. In this embodiment of the invention, transmission source identification and transmission-time stamp data is received and compared with programming and/or ad schedules for the corresponding media sources to determine the specific program or ad being viewed or listened to and the approximate time into that program or ad. This knowledge is then applied in the same or similar manner as the program ID and program time stamp to execute an ESM associated with that program or ad and thereby achieve synchronized information in addition to the content of the program being viewed or listened to.

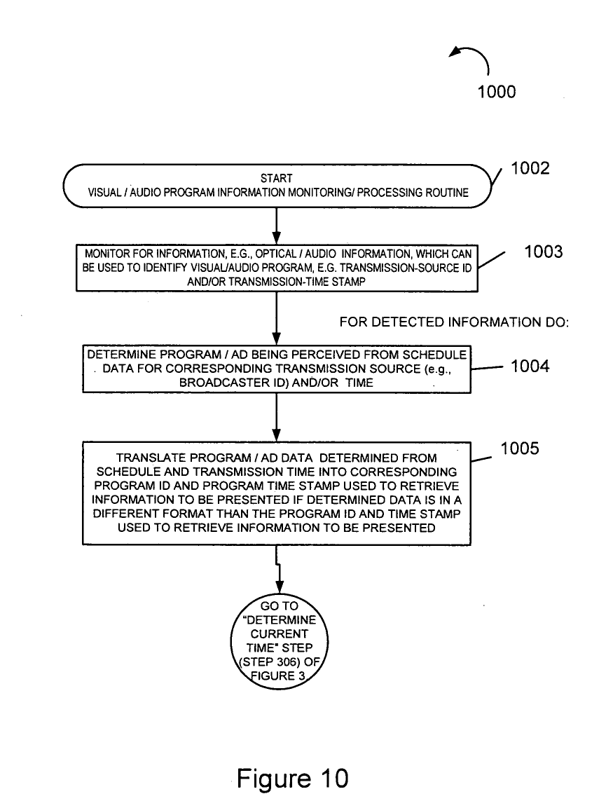

This alternative sub-process is illustrated in FIG. 10. These steps 1002 through 1005 perform a similar function to steps 302 and 304 in FIG. 3 and are used, in some embodiments, in place of steps 302 and 304. In step 1002, a visual/audio program information monitoring and processing routine begins when it is first loaded in the processor 120 and executed, e.g., as part of the start-up process of computer system 110. Operation proceeds from step 1002 to monitoring step 1003 which is performed on an ongoing basis. Optical monitoring, audio monitoring and/or other types of signal/presentation monitoring may be performed in step 1003. In step 1003, the computer system 110 monitors the output of one or more of the systems monitoring devices, e.g., visual information detector 106 and/or audio information detector 108 (which, for clarity, can be the standard microphone built in to the Internet-enabled device) for a transmission-source ID, such as a broadcaster ID, and/or transmission-time stamp which may be included in a program being output by a nearby output device such as a display device, e.g., exemplary television display 103 or speaker, e.g. of a television or radio. Each time a transmission-source ID or transmission-time stamp is detected, operation proceeds to step 1004.

In step 1004 the program being perceived is determined from broadcast and/or other presentation information, e.g., program schedule information which may be stored in a database, e.g., a TV guide, radio program or ad database. In this manner, program/ad schedule data for the corresponding transmission source and transmission time is retrieved and the presentation can be identified. In step 1005, this program/ad schedule data and transmission time is then translated to a corresponding program ID and program time stamp which can be used to retrieve information in a synchronized manner in accordance with the invention. Operation then proceeds to step 306 of FIG. 3 and continues as described previously.

It should be appreciated that in some embodiments, the broadcast identifier and time information, are used directly to determine what information should be retrieved and presented in a synchronized manner. That is, information to be retrieved and presented can be correlated directly to broadcaster ID and broadcast time information without having to determine the actual program being broadcast at a particular point in time.

Alternative embodiments of the invention include other methods of transmitting and detecting the program ID and program time stamps or transmission-source ID and transmission-time stamps to an information retrieval device, e.g., Internet-enabled device. Such alternatives include, but are not limited to, wired or wireless transmission methods, e.g. via infrared, Bluetooth, or a wireless network. The methods may detect signals from a wide variety of devices, e.g., a television, set-top box or set-top-box-connected device, or digital video recorder or various other devices including an Internet connected device.

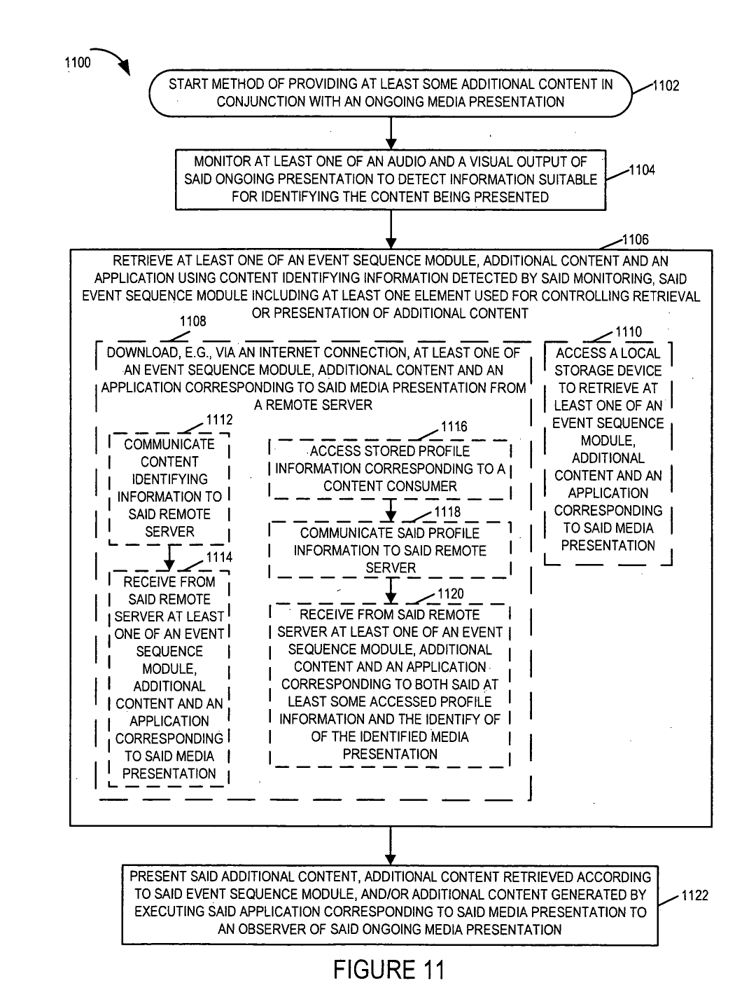

FIG. 11 is a drawing of a flowchart 1100 of an exemplary method of providing at least some additional content in conjunction with an ongoing media presentation. Operation of the exemplary method starts in step 1102 where a user device is powered on and initialized. Operation proceeds from start step 1102 to step 1104.

In step 1104, the user device monitors for at least one of an audio and a visual output of said ongoing presentation to detect information suitable for identifying the content being presented. In some embodiments, the detected information suitable for identifying the content being presented is not perceivable to an unaided human observer of said at least one of an audio and visual output. Operation proceeds from step 1104 to step 1106.

In step 1106, the user device retrieves at least one of an event sequence module, additional content and an application using content identifying information detected by said monitoring, said event sequence module including at least one element used for controlling retrieval or presentation of additional content. In various embodiments step 1106 includes one or more of steps 1108 and 1110.

In step 1108, the user device downloads, e.g., via an Internet connection, at least one of an event sequence module, additional content and an application corresponding to said media presentation from a remote server. In some embodiments step 1108 includes one of more of (i) sub-steps 1112 and 1114 and (ii) sub-steps 1116, 1118 and 1120.

In sub-step 1112, the user device communicates content identifying information to said remote server, then in step 1114, the user device receives from said remoter server at least one of an event sequence module, additional content and an application corresponding to said media presentation.

In sub-step 1116, the user device accesses stored profile information corresponding to a content consumer. Operation proceeds from sub-step 1116 to sub-step 1118. In sub-step 1118, the user device communicates said profile information to said remote server. Operation proceeds from sub-step 1118 to sub-step 1120. In sub-step 1120, the user device receives from said remote server at least one of an event sequence module, additional content and an application corresponding to both said at least some accessed profile information and the identify of the identified media presentation.

Returning to step 1110, in step 1110, the user device accesses a local storage device to retrieve at least one of an event sequence module, additional content and an application corresponding to said media presentation.

Operation proceeds from step 1106 to step 1122. In step 1122, the user device presents said additional content, additional content retrieved according to said event sequence module, and/or additional content generated by executing said application corresponding to said media presentation to an observer of said ongoing media presentation. In some embodiments, the presenting of said additional content of step 1122 is performed on a consumer device which is separate from a first output device which output the monitored at least one of said audio and visual output. In some embodiments said additional content is presented at a time which is coordinated with a portion of said media presentation.

In some embodiments, the media presentation is audio content. In some embodiments, the media presentation is video content. In some embodiments, the media presentation includes both audio and video content.

In various embodiments, said additional content is retrieved according to at least one element of said event sequence module. In some such embodiments, the additional content is retrieved substantially in advance of its intended presentation time as designated by said event sequence module.

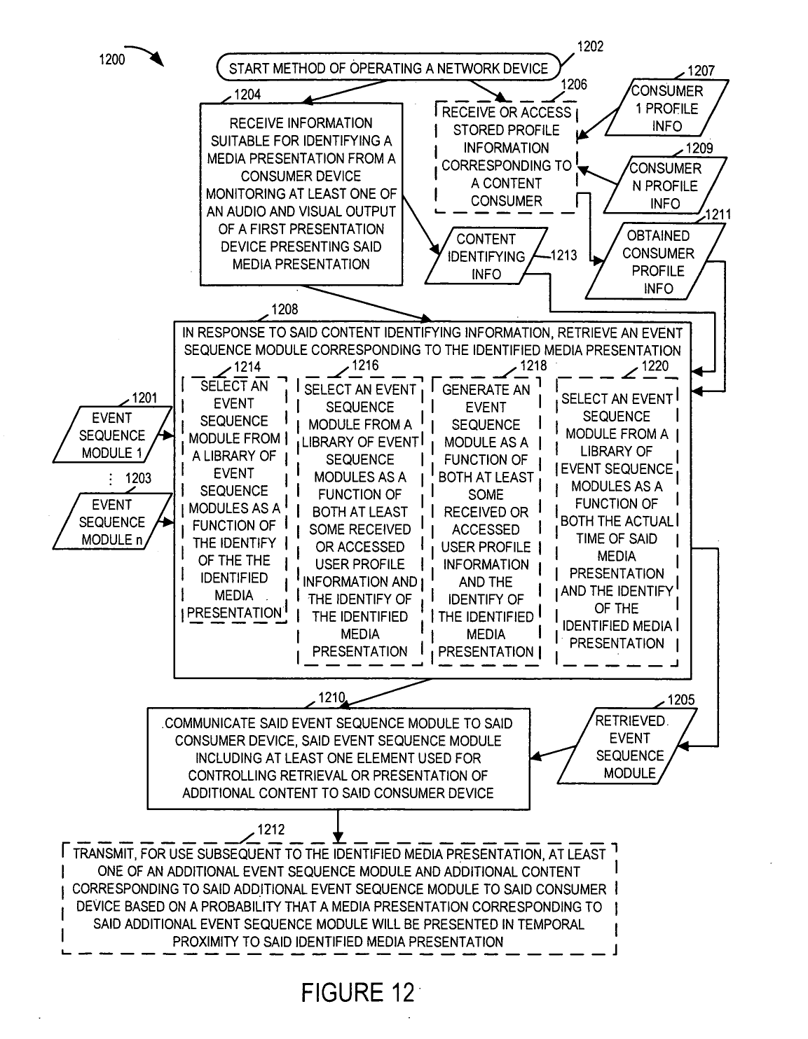

FIG. 12 is a drawing of a flowchart 1200 of an exemplary method of operating a network device in accordance with various embodiments. Operation starts in step 1202, where the network device is powered on and initialized. Operation proceeds from step 1202 to step 1204. In some embodiments, operation also proceeds from step 1202 to step 1206.

In step 1204, the network device receives information suitable for identifying a media presentation from a consumer device monitoring at least one of an audio and visual output of a presentation device presenting said media presentation. In some embodiments, the consumer device is a computer-based device and the presentation device is a television set. Content identifying information 1213 is an output from step 1204.

In step 1206, the network node receives or accesses stored profile information corresponding to a content consumer. Consumer 1 profile information 1207, . . . , consumer N profile information 1209 represents potential inputs to step 1206, while obtained consumer profile information 1211 is an output from step 1206.

Operation proceeds from step 1204 to step 1208. In step 1208, the network node, in response to said content identifying information 1213, retrieves an event sequence module corresponding to the identified media presentation. Content identifying information 1213 is an input to step 1208, while retrieved event sequence module 1205 is an output of step 1208. Event sequence module 1 1201, . . . , event sequence module n 1203, and/or obtained consumer profile information 1211 are, in some embodiments, inputs to step 1208.

In some embodiments, step 1208 includes one or more of sub-steps 1214, 1216, 1218, and 1220. In sub-step 1214 the network node selects an event sequence from a library of event sequence modules as a function of the identify of the identified media presentation. In sub-step 1216, the network node selects an event sequence module from a library of event sequence modules as a function of both at least some received or accessed user profile information and the identify of the identified media presentation. In sub-step 1218, the network node generates an event sequence module as a function of both at least some received or accessed user profile information and the identify of the identified media presentation. In some such embodiments, the content identifying information 1213 includes information sufficient to determine at least one of the content and distribution source of the media presentation. In some such embodiments, the content identifying information 1213 includes information sufficient to determine both the content and distribution source of the media presentation. In various embodiments, the content identifying information 1213 includes information sufficient to determine both the distribution source and actual time at which said distribution source broadcast said content. In sub-step 1220, the network node selects an event sequence module from a library of event sequence modules as a function of both the actual time of said media presentation and the identity of the identified media presentation.

Operation proceeds from step 1208 to step 1210. In step 1210, the network node communicates said retrieved event sequence module 1205 to said consumer device, said event sequence module including at least one element used for controlling retrieval or presentation of additional content to said consumer device.

In some embodiments, the event sequence module further includes synchronization information used for controlling delivery of additional content to said consumer device in synchronization with said identified media presentation. In some such embodiments, the synchronization information includes time information indicating a first point in time during said identified media presentation at which additional content indicated by said event sequence module is to be presented. In various embodiments, the event sequence module includes additional time information indicating an additional point in time during said identified media presentation at which further additional content indicated by said event sequence module is to be presented. In some embodiments, the indicated first point in time and said additional point in time are indicated by a value relative to the start of the media presentation.

In some embodiments, the event sequence module includes information indicating a location from which said additional content can be retrieved. In various embodiments, the event sequence module includes at least some of said additional content.

In some embodiments, the event sequence module includes a plurality of presentation times and corresponding actions, at least some actions corresponding to different presentation times and having different URLs associated with them. In some such embodiments, the different presentation times are referenced relative to the start of said identified media presentation.

In various embodiments, the event sequence module includes content to be presented at a point relative to a detected presented portion of said media presentation. In some such embodiments, times indicated in said event sequence module are expressed relative to the start of said media presentation and have a predetermined time relationship to points within the media presentation which may be detected.

In some embodiments, step 1212 is performed, and operation proceeds from step 1210 to step 1212. In step 1212, the network node, transmits, for use subsequent to the identified media presentation, at least one of an additional event sequence module and additional content corresponding to said additional event sequence module to said consumer device based on a probability that a media presentation corresponding to said additional event sequence module will be presented in temporal proximity to said identified media presentation.

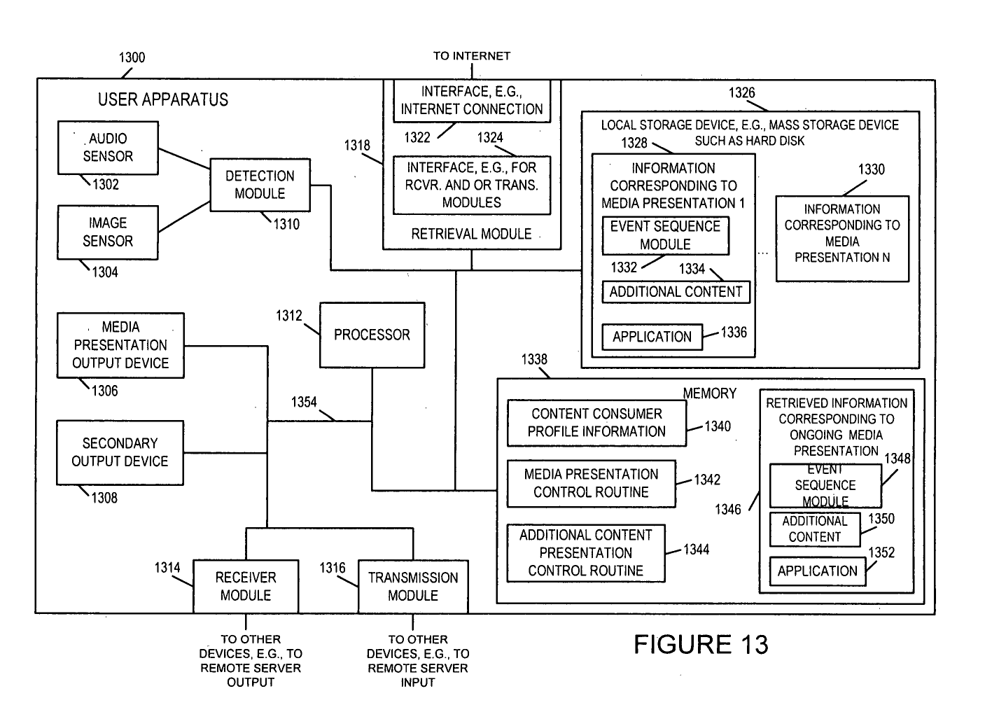

FIG. 13 is a drawing of a user apparatus 1300 in accordance with various embodiments of the present invention. Apparatus 1300 is used for providing at least some additional content in conjunction with an ongoing media presentation. User apparatus 1300 includes a detection module 1310, a retrieval module 1318, a receiver module 1314,a transmission module 1316, a media presentation output device 1306, a secondary output device 1308, a processor 1312, memory 1338, and a local storage device 1326 coupled together via a bus 1354 over which the various elements may interchange data and information. The memory 1338 includes routines and data/information.

The processor 1312, e.g., a CPU, executes the routines and uses the data/information in memory 1338 to control the operation of the user apparatus 1300 and implement methods in accordance with the present invention. The processor 1312 controls the presentation of additional content under the control of an event sequence module or an application corresponding to a media presentation to provide additional content in coordination with a portion of a media presentation. In some embodiments, the media presentation is audio content. In some embodiments, the media presentation is video content. In some embodiments the media presentation includes both audio and video content.

User apparatus 1300 also includes an audio sensor 1302 and an image sensor 1304 coupled to detection module 1310. The audio sensor 1302 detects an audio output of an ongoing media presentation and generates an output signal. The image sensor 1304 detects a video output of an ongoing media presentation and generates an output signal.

Detection module 1310 receives outputs from audio sensor 1302 and/or image sensor 1304 and identifies from the received sensor output information information suitable for identifying the content being presented.

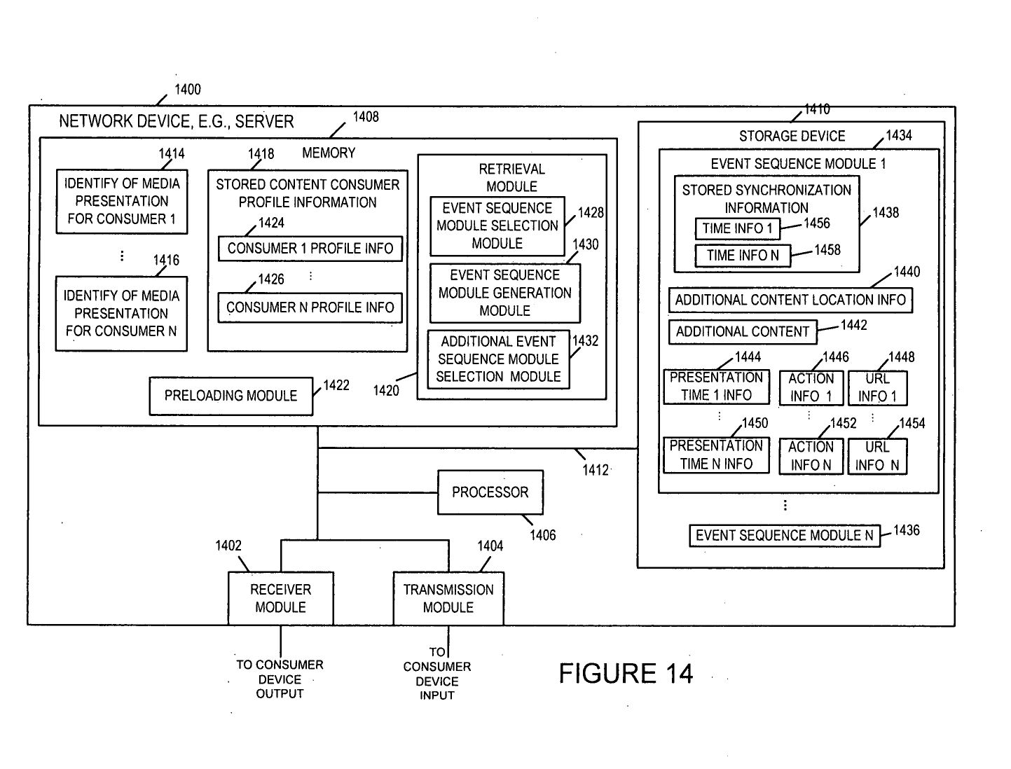

Retrieval module 1318 retrieves at least one of an event sequence module, additional content and an application using content identifying information obtained from the detection module 1310, said event sequence module including at least one element used for controlling retrieval or presentation of additional content. Retrieval module 1318 includes an interface(s) used for downloading at least one an event sequence module, additional content and an application corresponding to a media presentation from a remote server, e.g., device 1400 of FIG. 14. Retrieval module 1318 includes a first interface 1322, e.g., an Internet connection, and a second interface 1324, e.g., an interface for interfacing with the receiver 1314 and/or transmission module 1316.

Media presentation output device 1306 is used to output media presentations, e.g., an ongoing media presentation. Secondary output device 1308 is for presenting additional content, e.g., additional content retrieved according to an event sequence module or additional content generated by executing an application corresponding to an ongoing media presentation, to an observer of said ongoing media presentation. In some embodiments, the secondary output device 1308 and media presentation output device 1306 are separate displays.

The local storage device 1326, e.g., a mass storage device such as a hard disc, is accessible to the retrieval module 1318 and is used for locally storing information corresponding to media presentations. Local storage device 1326 includes information corresponding to a plurality of media presentations (information corresponding to media presentation 1 1328, . . . , information corresponding to media presentation N 1330). Information corresponding to media presentation 1 1328 includes an event sequence module 1332, additional content 1334, and an application 1336.

Transmission module 1316 communicates information content identifying information to network devices, e.g., remote servers. In some embodiments, the transmission module 1316 also communicates consumer profile information to network devices, e.g., remote servers.

Receiver module 1314 receives from a network device, e.g., a remote server, at least one of an event sequence module, additional content and an application corresponding to a media presentation.

Memory 1338 includes a media presentation control routine 1342, an additional content presentation routine 1344, content consumer profile information 1340 and retrieved information corresponding to an ongoing media presentation 1346. Retrieved information corresponding to an ongoing media presentation includes an event sequence module 1348, additional content 1350, and an application 1352.

Media presentation control routine 1342 is used by processor 1312 in controlling media presentation in output device 1306. Additional content presentation control routine 1344 is used by processor 1312 in controlling additional content presented in secondary output device 1308.

Content consumer profile information 1340 includes profile information corresponding to a user of apparatus 1300 which can be accessed by retrieval module 1318 and communicated to a remote server, e.g., via interface 1324 and transmission module 1316 or via interface 1322.

FIG. 14 is a drawing of an exemplary network device 1400, e.g., server, in accordance with various embodiments of the present invention. Exemplary network device 1400 includes a receiver module 1402, a transmission module 1404, a processor 1406, memory 1408 and a storage device 1410 coupled together via a bus 1412 over which the various elements may interchange data and information. Memory 1408 includes routines and data/information. The processor 1406, e.g., a CPU, executes the routines and uses the data/information in memory 1408 to control the operation of the network device 1400 and implement methods in accordance with the present invention.

Receiver module 1402 receives information suitable for identifying a media presentation from a consumer device monitoring at least one of an audio and video output of a first presentation device. Transmission module 1404 communicates an event sequence module, that was retrieved by the retrieval module 1420, to a consumer device, the event sequence module including at least one element used for controlling retrieval or presentation of additional content to the consumer device.

Memory 1408 includes a retrieval module 1420 and a preloading module 1422. Retrieval module 1420 retrieves at least one event sequence module corresponding to a media presentation. The retrieval module 1420 includes an event sequence module selection module 1428, an event sequence module generation module 1430 and an additional event sequence module selection module 1432. Event sequence module selection module 1428 and event sequence module generation module 1430 provide two alternatives to performing an event sequence module retrieval operation. The decision as to whether to use module 1428 or module 1430 is, in some embodiments, a function of the consumer profile information and/or the identify of the media presentation under consideration. Event sequence module selection module 1428 selects an event sequence module from a library of event sequence modules (event sequence module 1 1434, . . . , event sequence module N 1436). In some embodiments, the event sequence module selection module 1428 selects as a function of both at least some received or accessed user profile information and the identity of an identified media presentation. Event sequence module generation module 1430 generates an event sequence module. In some embodiments module 1430 generates as a function of both at least some received or accessed user profile information and the identify of an identified media presentation.

Additional event sequence module selection module 1432 selects an additional event sequence module based on a probability that a media presentation corresponding to the additional event sequence module will be presented in temporal proximity to the identified media presentation.

Preloading module 1422 is used for downloading to a consumer device at least one of an additional event sequence module selected by the additional event sequence module selection module 1432 and additional content, said additional content corresponding to said additional event sequence module.

Memory 1408 also includes information identifying media presentations corresponding to a plurality of consumers (identity of media presentation for consumer 1 1414, identity of media presentation for consumer N 1416) and stored content consumer profile information 1418 (consumer 1 profile information 1424, . . . , consumer N profile information 1426).

Storage device 1410 is accessible to the retrieval module 1420. Storage device 1410 includes a plurality of event sequence modules (event sequence module 1 1434, . . . , event sequence module N 1436). Event sequence module 1 1434 includes stored synchronization information 1438, additional content location information 1440, additional content 1442, presentation time 1 information 1444, action information 1446, URL information 1448, presentation time N information 1450, action information 1452 and URL information 1454.

The stored synchronization information 1438 is used for controlling delivery of additional content to a consumer device in synchronization with an identified media presentation. The stored synchronization information 1438 includes time information 1 1456, . . . , time information N 1458. Time information 1 indicates a first point in time during an identified media presentation to which event sequence module 1434 corresponds, at which additional content indicated by said event sequence module 1434 is to be presented. Time information N 1458 is additional time information indicating an additional point in time during the identified media presentation, to which the event sequence module 1434 corresponds, at which further additional content indicated by the event sequence module 1434 is to be presented. In some embodiments, the indicated first point in time corresponding to information 1456 and additional point in time corresponding to information 1458 are each indicated by a value relative to the start of the media presentation.

Additional content location information 1440 includes information indicating a location from which additional content can be received. In this exemplary embodiment, event sequence module 1434 includes a plurality of presentation times (presentation time 1 information 1444, . . . , presentation time N information 1450), and corresponding actions (action information 1 1446, . . . , action information N 1452), respectively, and at least some of the different presentation times have different URLs associated with them. For example presentation time 1 1444 may be associated with URL information 1 1448, while presentation time N 1450 may be associated with URL information N 1454, where URL 1 information 1448 is different than URL information N 1454. In some embodiments, the different presentation times (1444, . . . , 1450) are referenced to the start of an identified media presentation, to which event sequence module 1 1434 corresponds.

The techniques of the present invention may be implemented using software, hardware and/or a combination of software and hardware. The present invention is directed to apparatus, e.g., computers and/or various communications systems which implement the present invention. It is also directed to methods, e.g., methods of controlling and/or operating devices such as computer systems in accordance with the present invention. The present invention is also directed to machine readable medium, e.g., ROM, RAM, CDs, hard discs, etc., which include machine readable instructions for controlling a machine to implement one or more steps in accordance with the present invention.

Variations on the above described exemplary embodiments will be apparent to those skilled in the art in view of the above description of the invention. Such embodiments are considered to be part of the present invention.

What is claimed is:

1. A method of providing at least some additional content in conjunction with an ongoing media presentation, the method comprising:
monitoring at least one of an audio and a visual output of said ongoing presentation to detect information suitable for identifying the content being presented; and
retrieving at least one of an event sequence module, additional content and an application using content identifying information detected by said monitoring, said event sequence module including at least one element used for controlling retrieval or presentation of additional content.

2. The method of claim 1, wherein said step of retrieving at least one of an event sequence module, additional content and an application includes:
downloading at least one of an event sequence module, additional content and an application corresponding to said media presentation from a remote server.

3. The method of claim 2, wherein said downloading is performed via an Internet connection.

4. The method of claim 1, wherein said step of retrieving at least one of an event sequence module, additional content and an application includes:
accessing a local storage device to retrieve at least one of an event sequence module, additional content and an application corresponding to said media presentation.

5. The method of claim 2, wherein downloading at least one of an event sequence module, additional content and an application corresponding to said media presentation includes:
communicating content identifying information to said remote server; and
receiving from said server at least one of an event sequence module, additional content and an application corresponding to said media presentation.

6. The method of claim 5, further comprising:
accessing stored profile information corresponding to the content consumer and communicating said profile information to said remote server; and receiving from said server at least one of an event sequence module, additional content and an application corresponding to both at least some accessed profile information and the identity of the identified media presentation.

7. The method of claim 5, further comprising:
presenting said additional content, additional content retrieved according to said event sequence module, or additional content generated by executing said application corresponding to said media presentation to an observer of said ongoing media presentation.

8. The method of claim 7, wherein said presenting of said additional content is on a consumer device which is separate from a first output device which output the monitored at least one of said audio and visual output.

9. The method of claim 7, wherein said additional content is presented at a time which is coordinated with a portion of said media presentation.

10. The method of claim 1, wherein said media presentation is audio content.

11. The method of claim 1, wherein said media presentation is video content.

12. The method of claim 1, wherein said additional content is retrieved according to at least one element of said event sequence module.

13. The method of claim 12, wherein said additional content is retrieved substantially in advance of its intended presentation time as designated by said event sequence module.

14. The method of claim 1, wherein the detected information suitable for identifying the content being presented is not perceivable to an unaided human observer of said at least one of an audio and a visual output.

15. An apparatus for providing at least some additional content in conjunction with an ongoing media presentation, the apparatus comprising:
at least one of an audio and image sensor for detecting at least one of an audio and video output of said ongoing media presentation;
a detection module for receiving an output from said at least one audio and image sensor and for identifying from the sensor output information suitable for identifying the content being presented; and
a retrieval module for retrieving at least one of an event sequence module, additional content and an application using content identifying information obtained from said detection module, said event sequence module including at least one element used for controlling retrieval or presentation of additional content.

16. The apparatus of claim 15, wherein said retrieval module includes an interface used for downloading at least one of an event sequence module, additional content and an application corresponding to said media presentation from a remote server.

17. The apparatus of claim 16, wherein said interface is an Internet connection.

18. The apparatus of claim 15, further including:
a local storage device accessible to said retrieval module for locally storing at least one of an event sequence module, additional content and an application corresponding to said media presentation.

19. The apparatus of claim 16, further comprising:
a transmission module for communicating content identifying information to said remote server; and
a receiver module for receiving from said remote server at least one of an event sequence module, additional content and an application corresponding to said media presentation.

20. The apparatus of claim 19, further comprising:
memory including stored profile information corresponding to the content consumer which can be accessed by said retrieval module and communicated to said remote server.

21. The apparatus of claim 19, further comprising:
a separate output device which is in addition to the output device used to output said media presentation, for presenting said additional content, additional content retrieved according to said event sequence module, or additional content generated by executing said application corresponding to said media presentation to an observer of said ongoing media presentation.

22. The apparatus of claim 21, wherein said separate output device is a display device which is separate from a first display device used to output said media presentation.

23. The apparatus of claim 21, further comprising:
a processor for controlling presentation of said additional content under control of said event sequence module or said application corresponding to said media presentation to provide said additional content in coordination with a portion of said media presentation.

24. The apparatus of claim 15, wherein said media presentation is audio content.

25. The apparatus of claim 15, wherein said media presentation is video content.

26. A method of operating a network device, the method comprising:
receiving information suitable for identifying a media presentation from a consumer device monitoring at least one of an audio and a visual output of a first presentation device presenting said media presentation;
in response to said content identifying information, retrieving an event sequence module corresponding to the identified media presentation; and
communicating said event sequence module to said consumer device, said event sequence module including at least one element used for controlling retrieval or presentation of additional content to said consumer device.

27. The method of claim 26, wherein said event sequence module further includes synchronization information used for controlling delivery of additional content to said consumer device in synchronization with said identified media presentation.

28. The method of claim 26, wherein said first presentation device is a television set and said consumer device is a computer-based device.

29. The method of claim 27, wherein said synchronization information includes time information indicating a first point in time during said identified media presentation at which additional content indicated by said event sequence module is to be presented.

30. The method of claim 29, wherein said event sequence module includes additional time information indicating an additional point in time during said identified media presentation at which further additional content indicated by said event sequence module is to be presented.

31. The method of claim 30, wherein said indicated first point in time and said additional point in time are indicated by a value relative to the start of the media presentation.

32. The method of claim 30, wherein said event sequence module includes information indicating a location from which said additional content can be retrieved.

33. The method of claim 30, wherein said event sequence module includes at least some of said additional content.

34. The method of claim 26, wherein said event sequence module includes a plurality of presentation times and corresponding actions, at least some actions corresponding to different presentation times and having different URLs associated with them.

35. The method of claim 34, wherein said different presentations times are referenced relative to the start of said identified media presentation.

36. The method of claim 30, wherein said event sequence module includes content to be presented at a point relative to a detected presented portion of said media presentation.

37. The method of claim 36, wherein times indicated in said event sequence module are expressed relative to the start of said media presentation and have a predetermined time relationship to points within the media presentation which may be detected.

38. The method of claim 26, further comprising:
receiving or accessing stored profile information corresponding to said content consumer; and wherein said step of retrieving said event sequence module includes selecting an event sequence module from a library of event sequence modules as a function of both at least some received or accessed user profile information and the identity of the identified media presentation.

39. The method of claim 26, further comprising:
receiving or accessing stored profile information corresponding to said content consumer; and wherein said step of retrieving said event sequence module includes generating an event sequence module as a function of both at least some received or accessed user profile information and the identity of the identified media presentation.

40. The method of claim 39, wherein said content identifying information includes information sufficient to determined at least one of the content and distribution source of said media presentation.

41. The method of claim 40, wherein said content identifying information includes information sufficient to determine both the content and distribution source of the media presentation.

42. The method of claim 39, wherein said content identifying information includes information sufficient to determine both the distribution source and the actual time at which said distribution source broadcast said content.

43. The method of claim 26, further comprising:
wherein said step of retrieving said event sequence module includes selecting an event sequence module from a library of event sequence modules as a function of both the actual time of said media presentation and the identity of the identified media presentation.

44. The method of claim 26, further comprising:
transmitting, for use subsequent to the identified media presentation, at least one of an additional event sequence module and additional content corresponding to said additional event sequence module to a consumer device based on a probability that a media presentation corresponding to said additional event sequence module will be presented in temporal proximity to said identified media presentation.

45. A network device, comprising:
a receiver module for receiving, from a consumer device monitoring at least one of an audio and a visual output of a first presentation device, information suitable for identifying a media presentation;
a retrieval module for retrieving at least one event sequence module corresponding to said media presentation; and
a transmission module for communicating an event sequence module to said consumer device that was retrieved by said retrieval module, said event sequence module including at least one element used for controlling retrieval or presentation of additional content to said consumer device.

46. The network device of claim 45, further comprising:
a storage device, accessible to said retrieval module, said storage device including said event sequence module, said even sequence module further including stored synchronization information used for controlling delivery of additional content to said consumer device in synchronization with said identified media presentation.

47. The network device of claim 46, wherein said stored synchronization information includes time information indicating a first point in time during said identified media presentation at which additional content indicated by said event sequence module is to be presented.

48. The network device of claim 47, wherein said event sequence module included in said storage device further includes additional time information indicating an additional point in time during said identified media presentation at which further additional content indicated by said event sequence module is to be presented.

49. The network device of claim 48, wherein said indicated first point in time and said additional point in time are indicated by a value relative to the start of the media presentation.

50. The network device of claim 48, wherein said stored event sequence module includes information indicating a location from which said additional content can be retrieved.

51. The network device of claim 48, wherein said stored event sequence module includes at least some of said additional content.

52. The network device of claim 45, wherein stored said event sequence module includes a plurality of presentation times and corresponding actions, at least some actions corresponding to different presentation times and having different URLs associated with them.

53. The network device of claim 52, wherein said different presentations times are referenced relative to the start of said identified media presentation.

54. The network device of claim 45, further comprising:
stored profile information corresponding to said content consumer; and
wherein said retrieval module includes an event sequence module selection module for selecting an event sequence module from a library of event sequence modules as a function of both at least some received or accessed user profile information and the identity of the identified media presentation.

55. The network device of claim 45, further comprising:
stored profile information corresponding to said content consumer; and
wherein said retrieval module includes an event sequence module generation module for generating an event sequence module as a function of both at least some received or accessed user profile information and the identity of the identified media presentation.

56. The network device of claim 45, further comprising:
an additional event sequence module selection module for selecting an additional event sequence module based on a probability that a media presentation corresponding to said additional event sequence module will be presented in temporal proximity to said identified media presentation.

57. The network device of claim 56, further comprising:
a preloading module for downloading at least one of an additional event sequence module selected by said additional event sequence module selection module and additional content, said additional content corresponding to said additional event sequence module, to said consumer device.
